(19) United States
(12) Patent Application Publication
(10) Pub. No.: US 2018/0065503 A1
(43) Pub. Date: Mar. 8, 2018

(54) AUTONOMOUS TRAVELLING VEHICLE

(71) Applicant: Sharp Kabushiki Kaisha, Sakai City (JP)

(72) Inventors: Atsushi HIGUCHI, Sakai City (JP); Yoshitaka OKAHASHI, Sakai City (JP); Kyosuke TAKA, Sakai City (JP)

(21) Appl. No.: 15/690,349

(22) Filed: Aug. 30, 2017

(30) Foreign Application Priority Data
Sep. 6, 2016 (JP) 2016-173772

(51) Int. Cl. B60L 11/18; B60R 19/02; B60R 16/023; B60K 1/04; B60K 1/02; B60K 7/00; B62D 25/24

(52) U.S. Cl. CPC B60L 11/1879; B60R 19/02; B60R 16/0231; B62D 25/24; B60K 1/02; B60K 7/0007; B60K 1/04

(57) ABSTRACT

An autonomous travelling vehicle includes a driving unit configured to drive a vehicle body, a control unit configured to control the driving unit, a cable configured to electrically connect the driving unit and the control unit, a control unit containing frame configured to contain the control unit, and a driving unit containing frame configured to contain the driving unit.

### BACKGROUND

### 1. Field

The present disclosure relates to an autonomous travelling vehicle performing autonomous travelling while detecting an obstacle using a sensor or the like.

### 2. Description of the Related Art

In recent years, autonomous travelling vehicles performing autonomous travelling have been practicalized. Such an autonomous travelling vehicle includes a motor and a battery as a driving unit, and a control unit controls driving of the motor and the like using power supplied from the battery to cause travelling of a vehicle body. Furthermore, apart from the control unit for causing travelling of the vehicle, the autonomous travelling vehicle includes a unit for detecting an obstacle using an optical sensor to control an operation so as to avoid an accident.

Japanese Unexamined Patent Application Publication No. 2001-228919 discloses an autonomous travelling vehicle in which a bumper and a contact plate are provided on the periphery of a moving truck so as to detect contact with an obstacle to control travelling.

In the autonomous travelling vehicle disclosed in Japanese Unexamined Patent Application Publication No. 2001-228919, a driving device and a control device are mounted on the lower part of the moving truck and a container is mounted on the upper part so as to carry a target article. In such an autonomous travelling vehicle, a driving device and a control device are collectively mounted in proximity of the lower part of a moving truck. This causes a high possibility that heats, magnetic forces, vibrations, or the like generated during travelling of a battery and a motor included in the driving device are transmitted to the control device.

In the control device, a semiconductor integrated circuit and electronic parts are mounted, and heats, magnetic forces, vibrations, or the like applied thereto lead to failures such as erroneous operations and decreased longevity and thus are not desirable. However, when attempting to maintain a distance between the control device and the driving device to control transmission of heats, magnetic forces, vibrations, or the like on the lower part of the moving truck, a larger space has to be secured. This causes a difficulty in responding to demands of miniaturization. Furthermore, when a damping unit, a heat-insulating unit, a magnetic shielding unit, or the like is provided to protect the control device, the number of components is increased at the same time the weight of the vehicle body is increased. This also causes a difficulty in responding to demands of miniaturization.

In view of this, the present disclosure is to provide an autonomous travelling vehicle that enables to protect a control unit from heats, magnetic forces, vibrations, or the like generated during travelling of a vehicle body.

### SUMMARY

According to an aspect of the disclosure, there is provided an autonomous travelling vehicle including a driving unit configured to drive a vehicle body, a control unit configured to control the driving unit, a cable configured to electrically connect the driving unit and the control unit, a control unit containing frame configured to contain the control unit, and a driving unit containing frame configured to contain the driving unit.

### BRIEF DESCRIPTION OF THE DRAWINGS

FIG. 1 is a front view of an autonomous travelling vehicle according to a first embodiment;

FIG. 2 is a side cross-sectional view illustrating a frame structure of the autonomous travelling vehicle taken along the line II-II in FIG. 1;

FIG. 3 is a schematic cross-sectional view illustrating an internal structure of the autonomous travelling vehicle;

FIG. 4 is an upper cross-sectional view illustrating the internal structure of the autonomous travelling vehicle taken along the line IV-IV in FIG. 3;

FIG. 5 is a schematic perspective view illustrating a driving unit containing frame and a cover unit according to a second embodiment;

FIG. 6 is a diagram schematically illustrating an inside of the driving unit containing frame in a state in which the cover unit is opened in the second embodiment;

FIG. 7 is a diagram schematically illustrating the inside of the driving unit containing frame in a state in which the cover unit is closed in the second embodiment;

FIG. 8 is a diagram schematically illustrating an inside of a driving unit containing frame in a state in which a cover unit is opened in a third embodiment;

FIG. 9 is a diagram schematically illustrating the inside of the driving unit containing frame in a state in which the cover unit is closed in the third embodiment; and

FIG. 10 is a side cross-sectional view illustrating a frame structure of an autonomous travelling vehicle according to a fourth embodiment.

### DESCRIPTION OF THE EMBODIMENTS

### First Embodiment

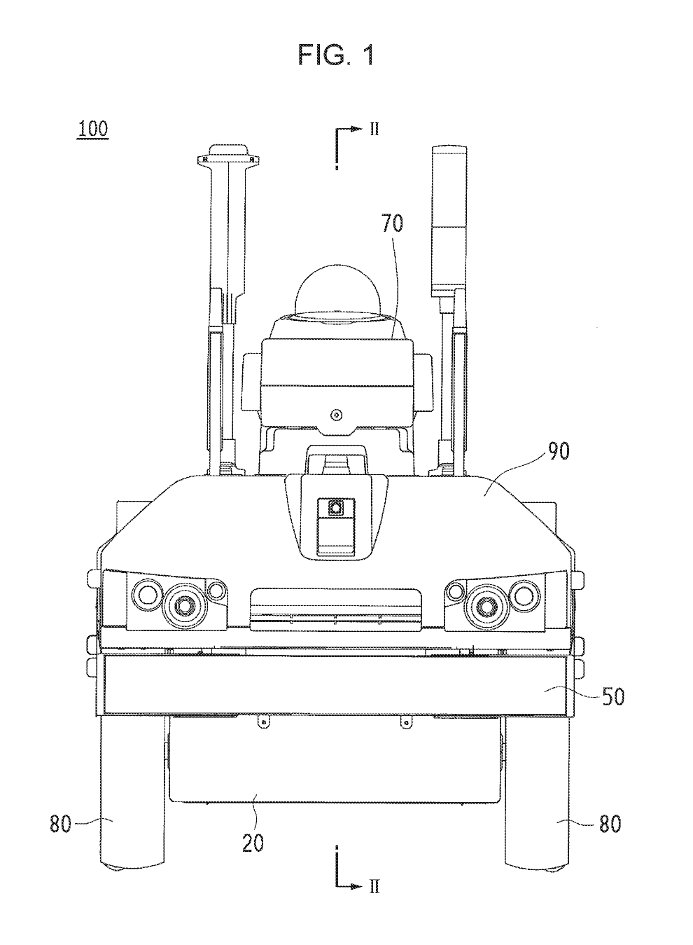

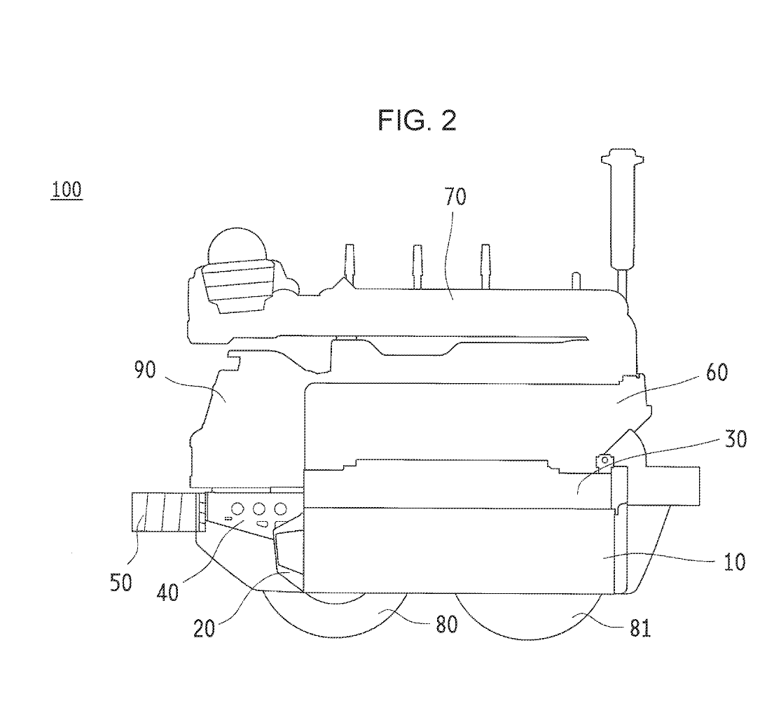

An autonomous travelling vehicle according to a first embodiment of the present disclosure will be described below with reference to the drawings. FIG. 1 is a front view of an autonomous travelling vehicle 100 according to a first embodiment. FIG. 2 is a side cross-sectional view illustrating a frame structure of the autonomous travelling vehicle 100 taken along the line II-II in FIG. 1.

As illustrated in FIGS. 1 and 2, the autonomous travelling vehicle 100 includes a driving unit containing frame 10, a cover unit 20, a control unit containing frame 30, a bumper supporting unit 40, a bumper unit 50, an upper frame 60, a boom 70, front wheels 80, rear wheels 81, and a body 90.

The driving unit containing frame 10 is a frame structure for containing a driving unit such as batteries 11 and motors 12 for driving the autonomous travelling vehicle 100. The details of the driving unit containing frame 10 will be described later. The frame structure forming the driving unit containing frame 10 may have a frame shape or a box shape as long as having a size and a strength enabling to contain and retain the driving unit. In view of protecting the driving unit to be contained inside, a box shape is desirable.

The cover unit 20 is a component openably and closably attached to the driving unit containing frame 10 at the front in the travelling direction of the autonomous travelling vehicle 100 with a space provided inside thereof. The cover unit 20 being openable and closable means that a closing state in which an internal space inside the cover unit 20 is closed by the driving unit containing frame 10 is able to be freely switched to an opening state in which the internal space is opened. Accordingly, various structures may be used, such as a structure in which one side of the cover unit 20 is rotatably attached to the driving unit containing frame 10 using a hinge mechanism or the like and the other side is engaged and a structure in which the entire cover unit 20 is removably mounted using a latch mechanism, an engaging claw, or the like.

The control unit containing frame 30 is a frame structure for containing a control unit for driving the autonomous travelling vehicle 100 and provided on the upper part of the driving unit containing frame 10. The details of the control unit containing frame 30 will be described later. The frame structure forming the control unit containing frame 30 may have a frame shape or a box shape as long as having a size and a strength enabling to contain and retain the control unit. In view of protecting the control unit to be contained inside, a box shape is desirable.

The bumper supporting unit 40 is a component attached to the front of the driving unit containing frame 10 and the control unit containing frame 30 to support the bumper unit 50. The specific shape of the bumper supporting unit 40 is not limited. However, one end of the bumper supporting unit 40 is fixed to the driving unit containing frame 10 and the control unit containing frame 30, and to the other end, the bumper unit 50 is attached, whereby the bumper unit 50 is retained with a predetermined gap secured from the driving unit containing frame 10 and the control unit containing frame 30. It is desirable that the predetermined gap is sized to enable a connection or removal operation of a cable 21 or a connector that is performed by an operator putting hands between the cover unit 20 and the driving unit containing frame 10 when the cover unit 20 is opened. For example, the gap is desirably in the range of about 10 cm to 50 cm.

The bumper unit 50 is a component attached to the tip of the bumper supporting unit 40 provided at the front of the autonomous travelling vehicle 100 to inhibit the body part of the autonomous travelling vehicle 100 from contacting an obstacle or the like. As a material forming the bumper unit 50, a resin material that is able to absorb an impact due to contact and to be deformed is desirable.

The upper frame 60 is a frame structure that is provided on the upper part of the control unit containing frame 30 to retain the body 90 or other component. The frame structure forming the upper frame 60 may have a frame shape or a box shape as long as having a size and a strength enabling to retain the body 90 or other component.

The boom 70 is a component in an arm shape that is provided on the upper parts of the upper frame 60 and the body 90. The boom 70 is pivotably supported by the upper frame 60 or the body 90, and driven with the angle thereof with respect to the travelling surface being changeable. The height of the tip of the boom 70 is able to be changed. On the boom 70, a detecting unit such as a camera, an optical sensor, a heat sensor, or the like is provided.

The front wheels 80 and the rear wheels 81 are wheels attached to the driving unit mounted in the driving unit containing frame 10 and are rotated on the travelling surface by power transmitted from the driving unit to move the autonomous travelling vehicle 100. Furthermore, the front wheels 80 and the rear wheels 81 have a steering wheel mechanism for selecting the travelling direction of the autonomous travelling vehicle 100.

The body 90 is an exterior part of the autonomous travelling vehicle 100 and is attached to the upper frame 60 while disposed so as to cover the upper part of a gap secured between the bumper unit 50 and the driving unit containing frame 10. The body 90 and the upper frame 60 are retained in a manner rotatable in up and down directions with a surface, at the side of the rear wheels 81, of the autonomous travelling vehicle 100 as an axis. In a state in which the body 90 and the upper frame 60 are rotated in the up direction, the upper part of the gap secured between the bumper unit 50 and the driving unit containing frame 10 is opened, so that the operator is able to access the gap from above.

Furthermore, to the body 90, parts that have to be provided on an autonomous travelling vehicle, such as a travelling state indication light, a warning light, a headlight, and a signal light, as well as detecting units such as a distance measurement sensor and a camera, are attached. Because the body 90 is disposed so as to cover the upper part of the gap secured between the bumper unit 50 and the driving unit containing frame 10, the headlight or the detecting units are able to be provided on possibly the most front position, thereby inhibiting the viewable range and the radiation range from being obstructed by the bumper unit 50 or the like. This enables to secure a wide viewable range and a wide radiation range.

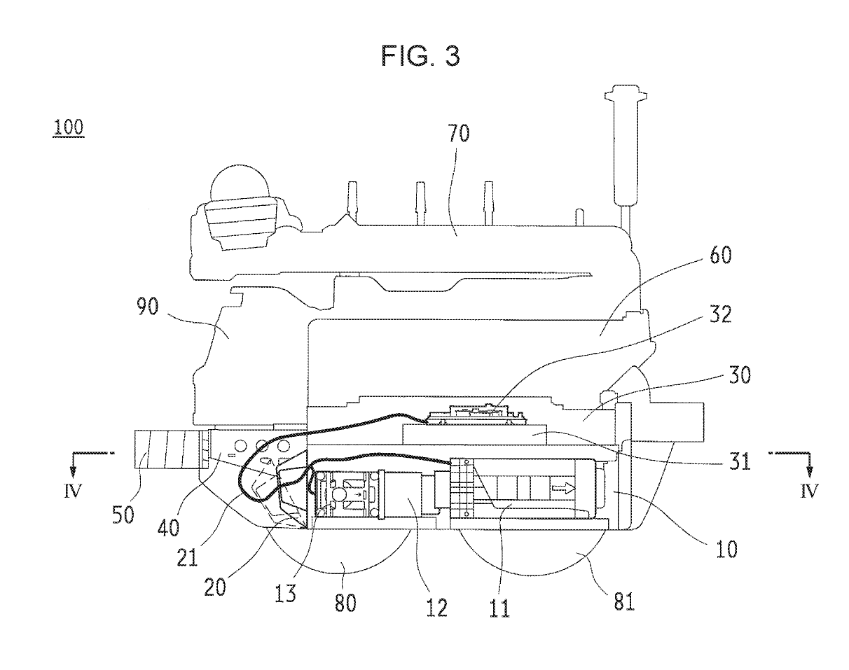

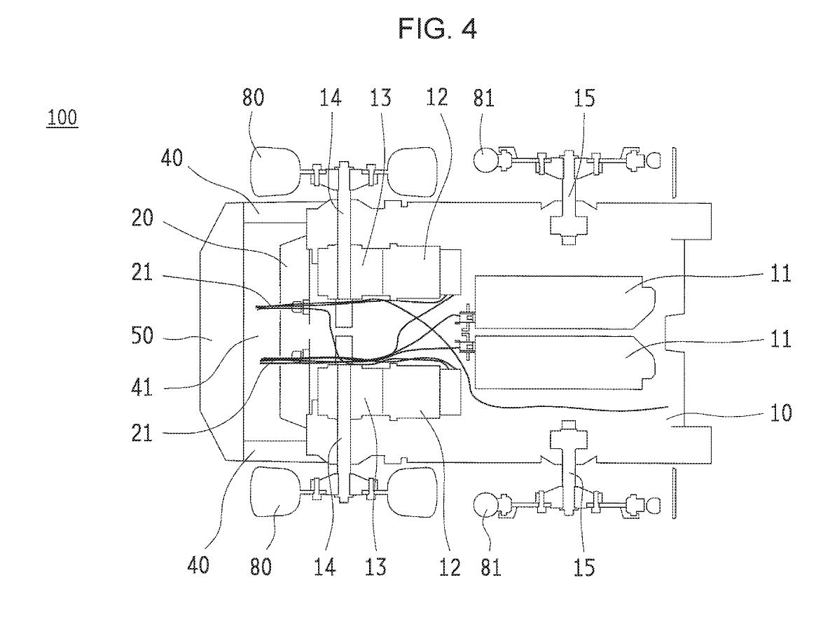

Next, an internal structure of the autonomous travelling vehicle 100 will be described in details with reference to FIGS. 3 and 4. FIG. 3 is a schematic cross-sectional view illustrating an internal structure of the autonomous travelling vehicle 100. FIG. 4 is an upper cross-sectional view illustrating the internal structure of the autonomous travelling vehicle 100 taken along the line IV-IV in FIG. 3.

As illustrated in FIGS. 3 and 4, in the driving unit containing frame 10, the batteries 11, the motors 12, gear boxes 13, front wheel shafts 14, and rear wheel shafts 15 are contained. Furthermore, in the control unit containing frame 30, a substrate retaining unit 31 and a control unit 32 are contained. At the front face of the driving unit containing frame 10, the bumper unit 50 is supported by the bumper supporting unit 40. Between the driving unit containing frame 10 and the bumper unit 50, a predetermined gap 41 is secured.

In this case, the batteries 11, the motors 12, and the gear boxes 13 form a part of the driving unit according to the present disclosure. Furthermore, the batteries 11 and the motors 12 are electrically connected to the control unit 32 via the cable 21.

The batteries 11 are secondary batteries disposed at the rear of the driving unit containing frame 10 and are power sources that supply accumulated powers to the control unit 32, the motors 12, and the like via the cable 21. The type of the batteries 11 is not limited as long as being able to appropriately supply adequate powers. For example, lithium ion batteries, nickel-metal-hydride batteries, nickel-cadmium batteries, or the like may be used. Furthermore, instead of secondary batteries, power generation elements such as alternators, fuel cells, and solar cells may be used as the power sources.

The motors 12 are power sources that each convert electric energy into a rotary motion using the power supplied thereto. The type of the motors 12 is not limited as long as being able to appropriately convert the power supplied thereto into a rotary motion, and may be a direct current motor or an alternate current motor. Furthermore, the motors 12 are connected to the control unit 32 via the cable 21. The motors 12 may receive the powers supplied from the control unit 32 via the cable 21, and the drive control of the motors 12 may be performed with drive control signals transmitted via the cable 21.

The gear boxes 13 each are a gear mechanism by which a rotary motion generated by the motor 12 is converted into a torque and a number of rotations appropriate for an operation of the autonomous travelling vehicle 100. The type of the gear mechanism forming the gear box 13 is not limited. The gear mechanism may include a transmission mechanism for changing a gear ratio, and may use continuously variable transmission or the like.

The front wheel shafts 14 are rotary shafts coupled to the output sides of the gear boxes 13. The both ends of the front wheel shafts 14 are drawn to the outside of the driving unit containing frame 10. To the both ends, the front wheels 80 are attached. The rear wheel shafts 15 are rotary shafts which are rotatably supported at the rear of the driving unit containing frame 10. One end of each of the rear wheel shafts 15 is drawn to the outside of the driving unit containing frame 10 and has a rear wheel 81 attached thereto. The rear wheel shafts 15 are coupled to the front wheel shafts 14 using a power transmission unit (not illustrated) such as a pulley and a belt. With the rotation of the front wheel shafts 14, the rear wheel shafts 15 are also rotated, so that the autonomous travelling vehicle 100 travels by four-wheel driving. In this case, an example of four-wheel driving is presented. However, the power transmission unit may be omitted and two-wheel driving may be used.

The cable 21 electrically connects the batteries 11 and the motors 12 contained in the driving unit containing frame 10 to the control unit 32 contained in the control unit containing frame 30. In this case, as illustrated in FIGS. 3 and 4, the cable 21 is taken out to the outside from the front of the driving unit containing frame 10 and introduced into the control unit containing frame 30 to be connected to the control unit 32, via the internal space inside the cover unit 20 and via the gap between the control unit containing frame 30 and the bumper unit 50.

The substrate retaining unit 31 is a component mounted in the control unit containing frame 30 to retain the control unit 32. As a material and a structure for forming the substrate retaining unit 31, it is desirable to use ones capable of controlling transmission of heats, magnetic forces, vibrations, and the like from the side of the driving unit containing frame 10 to the control unit 32.

The control unit 32 is a component that controls operations of the batteries 11, the motors 12, the gear boxes 13, and the like and is an information processing device in which a semiconductor integrated circuit and electronic parts are mounted on a printed wiring board or the like. The control unit 32 has a function of controlling driving of the batteries 11, the motors 12, the gear boxes 13, and the like which form a driving unit, as described above. However, the control unit 32 may have a function of controlling of the steering wheels, processing information acquired through a detecting unit, controlling driving of other components, and the like.

In a state in which the cover unit 20 is closed, the cable 21 is drawn out from the driving unit containing frame 10 and passes through the internal space inside the cover unit 20 to be taken out to the outside from the front of the cover unit 20. In this state in which the cover unit 20 is closed, the cable 21 is contained in the internal space. Furthermore, the cable 21 passes through the gap secured between the bumper unit 50 and the control unit containing frame 30 to be connected to the control unit 32 inside the control unit containing frame 30. This enables to secure the gap between the internal space inside the cover unit 20 and the outside, thereby suppressing a bending stress from being applied on the cable 21 and enabling to control a damage of the cable 21. Furthermore, because the internal space is closed by the driving unit containing frame 10 and the cover unit 20, it is possible to effectively protect the driving unit including the batteries 11, the motors 12, the gear boxes 13, the front wheel shafts 14, the rear wheel shafts 15, and the like.

Furthermore, in a state in which the cover unit 20 is opened, when the cover unit 20 is opened, a tension is applied on the cable 21 in back and forth directions to pull the cable 21, so that the cable 21 is released from containment into the internal space to be exposed between the cover unit 20 and the driving unit containing frame 10. When the cover unit 20 is opened, the front side of the driving unit containing frame 10 is also opened, making it easy for the operator to access the inside of the driving unit containing frame 10 to perform operations such as connection and removal of a cable 21.

The cover unit 20 is able to be opened and closed by switching between engagement and release, as illustrated in FIG. 3 with a broken line. This enables to achieve both of easy connection operations of the cable 21 and protection of the driving unit provided inside the driving unit containing frame 10.

Furthermore, the driving unit containing frame 10 and the control unit containing frame 30 are frames separated from each other. This enables to control transmission of heats, magnetic forces, vibrations, or the like generated in the driving unit provided in the driving unit containing frame 10 to the control unit 32 provided in the control unit containing frame 30, and effectively protect the control unit 32 to suppress erroneous operations and decreased longevity.

In particular, by disposing the control unit containing frame 30 in a position higher than the driving unit containing frame 10, the driving unit which has a relatively heavy weight is positioned in a low position to lower the center of gravity, thereby promoting stabilization of the autonomous travelling vehicle 100. This also enables to secure the distance from the travelling surface to the control unit containing frame 30, thereby controlling transmission of heats or vibrations generated between the travelling surface and the front wheels 80 or the rear wheels 81 to the control unit 32.

As described above, the driving unit containing frame 10 and the control unit containing frame 30 are frames separated from each other, whereby the autonomous travelling vehicle 100 according to the present disclosure is able to protect the control unit from heats, magnetic forces, vibrations, or the like generated during travelling of the vehicle body.

### Second Embodiment

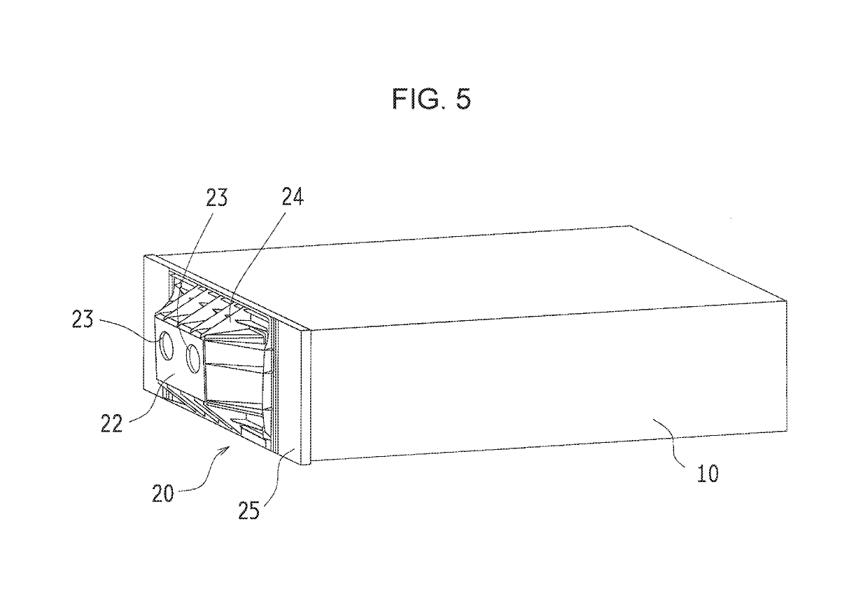

Next, a second embodiment according to the present disclosure will be described in details with reference to the drawings. Descriptions of configurations common to those in the first embodiment will be omitted. FIG. 5 is a schematic perspective view illustrating the driving unit containing frame 10 and the cover unit 20 according to the second embodiment.

The driving unit containing frame 10 according to the present disclosure has a substantially rectangular parallelepiped shape having an opening at the front side of the autonomous travelling vehicle 100, to which the cover unit 20 is attached. Although an example of the driving unit containing frame 10 having a substantially rectangular parallelepiped shape is presented in this case, the specific shape thereof is not limited as long as the cover unit 20 is attached to the part of the opening thereof.

The cover unit 20 includes a raised face 22, cable outlet holes 23, side face parts 24, and closed faces 25. The raised face 22 is a face that is supported by the side face parts 24 to protrude to a position ahead of the closed faces 25 and has the cable outlet holes 23 formed on a part of the raised face 22. The closed faces 25 have external shapes that cover the opening part of the driving unit containing frame 10. In a state in which the cover unit 20 is closed, the closed faces 25 covers the driving unit containing frame 10 to cause a closed state thereof.

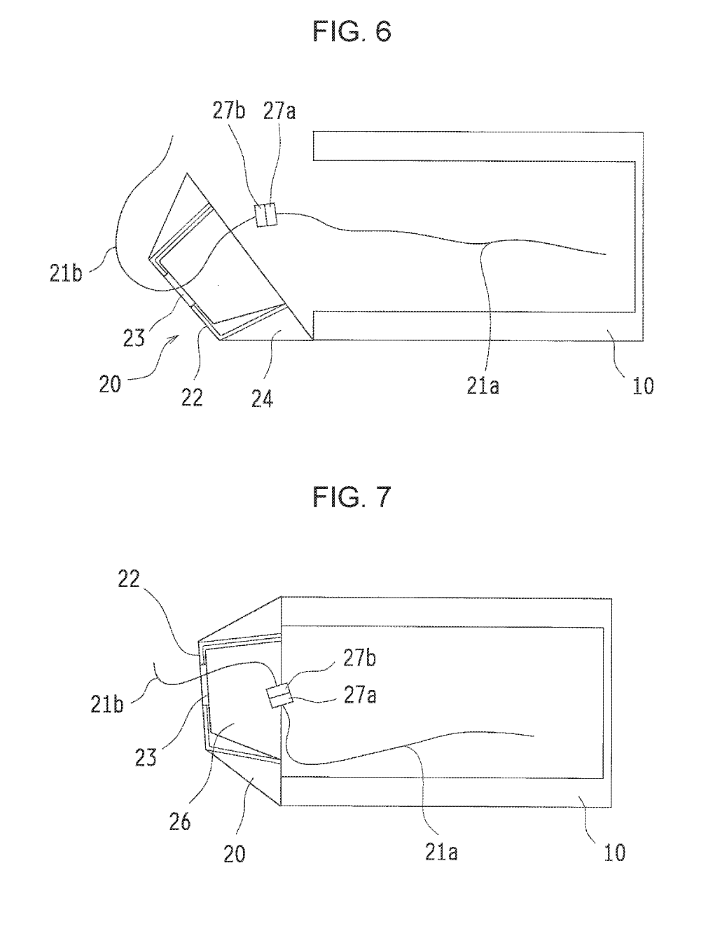

FIG. 6 is a diagram schematically illustrating an inside of the driving unit containing frame 10 in a state in which the cover unit 20 is opened. FIG. 7 is a diagram schematically illustrating the inside of the driving unit containing frame 10 in a state in which the cover unit 20 is closed. The cover unit 20 has an internal space 26 surrounded by the raised face 22 and the side face parts 24.

The cable 21 according to the present disclosure is separated into an internal cable 21a and an external cable 21b. On the end of the internal cable 21a, a connector 27a is provided. On the end of the external cable 21b, a connector 27b is provided. The internal cable 21a is connected to the driving unit in the inside of the driving unit containing frame 10. The external cable 21b passes through a cable outlet hole 23 from the outside of the cover unit 20 to be drawn into the internal space 26. The connector 27a and the connector 27b are shaped so as to fit into each other. By fitting connector 27a and the connector 27b into each other, the internal cable 21a and the external cable 21b are electrically connected to each other.

As illustrated in FIG. 6, in a state in which the cover unit 20 is opened, the internal cable 21a and the external cable 21b are pulled in both directions and have a tension applied thereto. The internal cable 21a, the external cable 21b, and the connectors 27a and 27b are released from containment into the internal space 26 to be exposed between the cover unit 20 and the driving unit containing frame 10. When the cover unit 20 is opened, the front face of the driving unit containing frame 10 is also opened, making it easy for the operator to access the internal space 26 and the inside of the driving unit containing frame 10 to perform operations such as connection and removal of the internal cable 21a, the external cable 21b, and the connectors 27a and 27b.

As illustrated in FIG. 7, in a state in which the cover unit 20 is closed, each of the internal cable 21a and the external cable 21b is deformed into a predetermined shape depending on the length, flexibility, and relative positional relation with other component, and contained into the inside of the driving unit containing frame 10 and the internal space 26, respectively. Furthermore, the connectors 27a and 27b are also contained in a predetermined position in the internal space 26 in a state being connected to each other.

In the present embodiment, the connectors 27a and 27b are used to connect the internal cable 21a and the external cable 21b, making it easy to perform a connection operation in a state in which the cover unit 20 is opened. Furthermore, the internal cable 21a, the external cable 21b, and the connectors 27a and 27b are contained in predetermined positions in the internal space 26 inside the cover unit 20 in a state in which the cover unit 20 is closed. This enables to suppress damages due to entrapment of the internal cable 21a, the external cable 21b, and the connectors 27a and 27b.

Furthermore, it is possible to limit the positions where the internal cable 21a, the external cable 21b, and the connectors 27a and 27b are contained to the predetermined positions in the internal space 26. With this, no space for containing the connectors 27a and 27b has to be provided inside the driving unit containing frame 10, enabling to promote miniaturization.

### Third Embodiment

Next, a third embodiment according to the present disclosure will be described in details with reference to the drawings. Descriptions of configurations common to those in the second embodiment will be omitted.

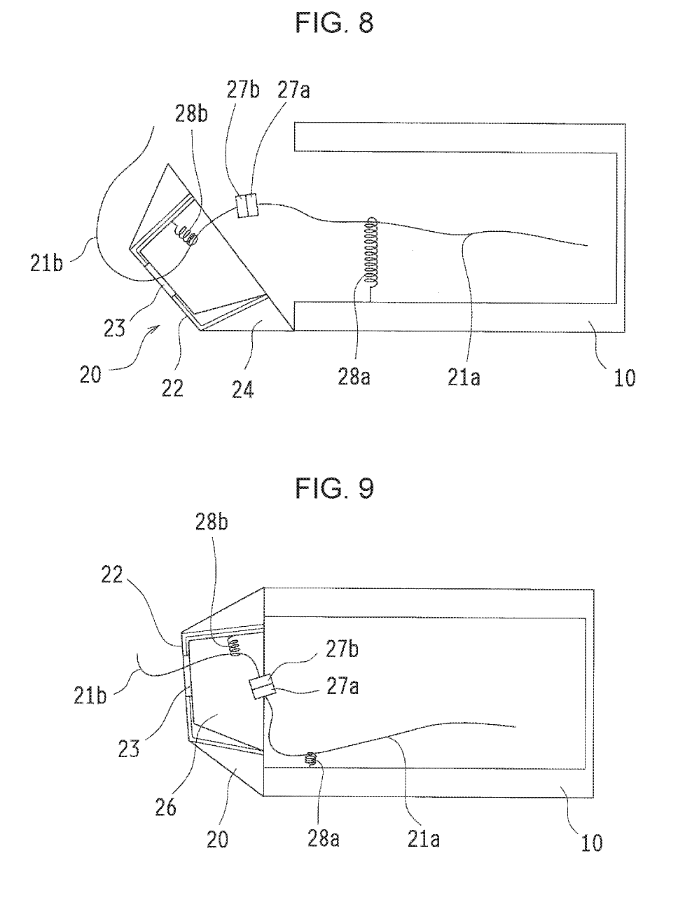

FIG. 8 is a diagram schematically illustrating the inside of the driving unit containing frame 10 in a state in which the cover unit 20 is opened. FIG. 9 is a diagram schematically illustrating the inside of the driving unit containing frame 10 in a state in which the cover unit 20 is closed. The cover unit 20 has the internal space 26 surrounded by the raised face 22 and the side face parts 24.

On the bottom face of the inside of the driving unit containing frame 10 and the top face of the inside of the cover unit 20, energizing members 28a and 28b such as springs are provided, respectively. The energizing member 28a energizes a predetermined position of the internal cable 21a in the direction of the bottom face. The energizing member 28b energizes a predetermined position of the external cable 21b in the direction of the top face. Although springs are exemplified as the energizing members 28a and 28b, the specific configuration is not limited as long as being able to energize the internal cable 21a and the external cable 21b in the predetermined directions. Furthermore, the directions in which the internal cable 21a and the external cable 21b are energized are not limited to the directions of the top face and the bottom face.

As illustrated in FIG. 8, in a state in which the cover unit 20 is opened, the internal cable 21a and the external cable 21b are pulled in both directions and have a tension applied thereto. With this, the energizing members 28a and 28b are elastically deformed, and the internal cable 21a, the external cable 21b, and the connectors 27a and 27b are released from containment into the internal space 26 to be exposed between the cover unit 20 and the driving unit containing frame 10. When the cover unit 20 is opened, the front face of the driving unit containing frame 10 is also opened, making it easy for the operator to access the internal space 26 and the inside of the driving unit containing frame 10 to perform operations such as connection and removal of the internal cable 21a, the external cable 21b, and the connectors 27a and 27b.

As illustrated in FIG. 9, in a state in which the cover unit 20 is closed, the internal cable 21a and the external cable 21b are energized to the directions of the bottom face and the top face by the energizing members 28a and 28b, respectively. The internal cable 21a and the external cable 21b are deformed into predetermined shapes and contained in the driving unit containing frame 10 and the internal space 26, respectively. Furthermore, the connectors 27a and 27b are also contained in the predetermined positions in the internal space 26 in a state being connected to each other.

In the present embodiment, the connectors 27a and 27b are used to connect the internal cable 21a and the external cable 21b, making it easy to perform a connection operation in a state in which the cover unit 20 is opened. Furthermore, the energizing members 28a and 28b energize the predetermined positions of the internal cable 21a and the external cable 21b, and thus the internal cable 21a, the external cable 21b, and the connectors 27a and 27b are contained in the predetermined positions in the internal space 26 inside the cover unit 20 in a state in which the cover unit 20 is closed. This enables to suppress damages due to entrapment of the internal cable 21a, the external cable 21b, and the connectors 27a and 27b.

Furthermore, it is possible to limit the positions where the internal cable 21a, the external cable 21b, and the connectors 27a and 27b are contained to the predetermined positions in the internal space 26. With this, no space for containing the connectors 27a and 27b has to be provided inside the driving unit containing frame 10, enabling to promote miniaturization.

### Fourth Embodiment

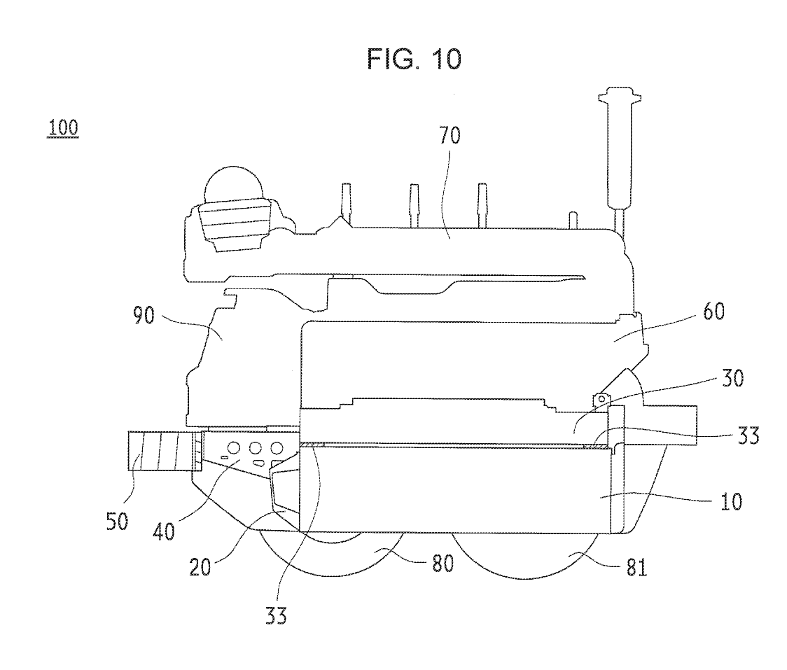

Next, a fourth embodiment according to the present disclosure will be described in details with reference to the drawings. Descriptions of configurations common to those in the first embodiment will be omitted. FIG. 10 is a side cross-sectional view illustrating a frame structure of the autonomous travelling vehicle 100 according to the fourth embodiment.

As illustrated in FIG. 10, the autonomous travelling vehicle 100 includes the driving unit containing frame 10, the cover unit 20, the control unit containing frame 30, vibration absorbing members 33, the bumper supporting unit 40, the bumper unit 50, the upper frame 60, the boom 70, the front wheels 80, the rear wheels 81, and the body 90.

The control unit containing frame 30 is disposed in a manner stacked on the driving unit containing frame 10 via the vibration absorbing members 33. Faces of the control unit containing frame 30 and the driving unit containing frame 10 that overlap each other have substantially the same shape. On four corners of each of the faces, the vibration absorbing members 33 are disposed. As a vibration absorbing member 33, a helical vibration isolator or a wire rope vibration isolator such as a compact rope vibration isolator may be used.

With this, vibrations transmitted from the driving unit containing frame 10 to the control unit containing frame 30 are absorbed by the vibration absorbing members 33. This enables to effectively control transmission of vibrations or the like to the control unit 32 disposed in the control unit containing frame 30 and effectively protect the control unit 32 to suppress erroneous operations and decreased longevity.

### Fifth Embodiment

In the first to the fourth embodiments, examples in which the cover unit 20 being openable and closable is provided at the front of the driving unit containing frame 10 are described. However, the cover unit 20 may be provided at the front of the control unit containing frame 30 so that the connectors 27a and 27b are contained in the internal space inside the cover unit 20. Furthermore, the bumper unit 50 and the cover unit 20 may be provided at the rear of the driving unit containing frame 10 or the control unit containing frame 30 so that the cable 21 is connected at the rear of the autonomous travelling vehicle 100.

Furthermore, in the first to the fourth embodiments, examples in which the batteries 11 and the motors 12 are provided as the driving unit are described. However, any configuration may be employed as long as a control signal is transmitted from the control unit 32 via the cable 21 so that the drive control is performed based on the control signal.

The present disclosure is not limited to the embodiments described above and various modifications disclosed in the appended claims may be applied. An embodiment obtained by combining as appropriate technical units disclosed in different embodiments is to be included in the technical scope of the present disclosure.

The present disclosure contains subject matter related to that disclosed in Japanese Priority Patent Application JP 2016-173772 filed in the Japan Patent Office on Sep. 6, 2016, the entire contents of which are hereby incorporated by reference.

What is claimed is:

1. An autonomous travelling vehicle comprising:
a driving unit configured to drive a vehicle body;
a control unit configured to control the driving unit;
a cable configured to electrically connect the driving unit and the control unit;
a control unit containing frame configured to contain the control unit; and
a driving unit containing frame configured to contain the driving unit.

2. The autonomous travelling vehicle according to claim 1, wherein
the control unit containing frame is provided on the upper part of the driving unit containing frame.

3. The autonomous travelling vehicle according to claim 2, wherein
the control unit containing frame is disposed in a manner stacked on the driving unit containing frame via a vibration absorbing member.

4. The autonomous travelling vehicle according to claim 1, further comprising:
a bumper unit at the front of the control unit containing frame or the driving unit containing frame, wherein
a gap is provided between the control unit containing frame or the driving unit containing frame and the bumper unit, and
the cable electrically connects the driving unit and the control unit via the gap.

5. The autonomous travelling vehicle according to claim 2, further comprising:
a bumper unit at the front of the control unit containing frame or the driving unit containing frame, wherein
a gap is provided between the control unit containing frame or the driving unit containing frame and the bumper unit, and
the cable electrically connects the driving unit and the control unit via the gap.

6. The autonomous travelling vehicle according to claim 3, further comprising:
a bumper unit at the front of the control unit containing frame or the driving unit containing frame, wherein
a gap is provided between the control unit containing frame or the driving unit containing frame and the bumper unit, and
the cable electrically connects the driving unit and the control unit via the gap.

7. The autonomous travelling vehicle according to claim 1, further comprising:
a cover unit being openable and closable that has an internal space adjacent to the control unit containing frame or the driving unit containing frame, wherein
the cable electrically connects the driving unit and the control unit via the internal space inside the cover unit.

8. The autonomous travelling vehicle according to claim 2, further comprising:
a cover unit being openable and closable that has an internal space adjacent to the control unit containing frame or the driving unit containing frame, wherein
the cable electrically connects the driving unit and the control unit via the internal space inside the cover unit.

9. The autonomous travelling vehicle according to claim 3, further comprising:
a cover unit being openable and closable that has an internal space adjacent to the control unit containing frame or the driving unit containing frame, wherein
the cable electrically connects the driving unit and the control unit via the internal space inside the cover unit.

10. The autonomous travelling vehicle according to claim 7, wherein
in a state in which the cover unit is closed, the cable is contained in the internal space.

11. The autonomous travelling vehicle according to claim 8, wherein
in a state in which the cover unit is closed, the cable is contained in the internal space.

12. The autonomous travelling vehicle according to claim 9, wherein
in a state in which the cover unit is closed, the cable is contained in the internal space.

13. The autonomous travelling vehicle according to claim 7, wherein
the cable is connected via a connector, and
in a state in which the cover unit is opened, the connector is exposed between the cover unit and the driving unit containing frame.

14. The autonomous travelling vehicle according to claim 8, wherein
the cable is connected via a connector, and
in a state in which the cover unit is opened, the connector is exposed between the cover unit and the driving unit containing frame.

15. The autonomous travelling vehicle according to claim 9, wherein
the cable is connected via a connector, and
in a state in which the cover unit is opened, the connector is exposed between the cover unit and the driving unit containing frame.

16. The autonomous travelling vehicle according to claim 7, wherein
any one of the control unit containing frame, the driving unit containing frame, and the cover unit includes an energizing unit configured to energize the cable in one direction.

17. The autonomous travelling vehicle according to claim 8, wherein
any one of the control unit containing frame, the driving unit containing frame, and the cover unit includes an energizing unit configured to energize the cable in one direction.

18. The autonomous travelling vehicle according to claim 9, wherein
any one of the control unit containing frame, the driving unit containing frame, and the cover unit includes an energizing unit configured to energize the cable in one direction.
